(19) United States
(12) Patent Application Publication
(10) Pub. No.: US 2012/0237746 A1
(43) Pub. Date: Sep. 20, 2012

(54) Multi-Layer Polymeric Films and Methods of Forming Same

(76) Inventors: Hugh Joseph O'Donnell, Cincinnati, OH (US); Daniel Charles Peck, Cincinnati, OH (US); Pier-Lorenzo Caruso, Frankfurt am Main (DE)

(21) Appl. No.: 13/421,079

(22) Filed: Mar. 15, 2012

Related U.S. Application Data
(60) Provisional application No. 61/454,132, filed on Mar. 18, 2011.

(51) Int. Cl. B32B 27/32; D01D 5/12; B32B 27/00; B32B 27/18; B32B 27/08

(52) U.S. Cl. 428/216; 428/411.1; 428/515; 428/215; 264/210.1

(57) ABSTRACT

A multi-layer polymeric film having an “A” layer and a “B” layer. The “A” layer includes a first polymer and a first inclusion substantially disposed therein. The first inclusion is a first material that has a higher elastic modulus than the first polymer. The “B” layer includes a second polymer and a second inclusion substantially disposed therein. The second inclusion is a second material that has a higher elastic modulus than the second polymer. Methods of forming a multi-layer film are also provided.

### CROSS-REFERENCE TO RELATED APPLICATIONS

This application claims the benefit of U.S. Provisional patent application Ser. No. 61/454,132, filed Mar. 18, 2011; and U.S. patent application Ser. No. 13/084,630, filed Apr. 12, 2011.

### TECHNICAL FIELD

The present disclosure generally relates to multi-layer polymeric films and methods of forming the same.

### BACKGROUND

Many products today require highly engineered components and yet, at the same time, these products are required to be limited use or disposable items. By limited use or disposable, it is meant that the product and/or component is used only a small number of times or possibly only once before being discarded. Examples of such products include, but are not limited to, personal care absorbent products such as diapers, training pants, incontinence garments, sanitary napkins, bandages, wipes and the like, as well as products such as packaging materials, and other disposable products such as trash bags and food bags. These types of products can and do utilize films. When films are used in limited use and/or disposable products, the impetus for maximizing engineered properties while reducing cost is extremely high.

In the area of films, there have been previous attempts to make multi-layer films having reduced thicknesses and certain opacifying characteristics. For example, U.S. Pat. No. 5,261,899 to Visscher describes a three layer film made with a central layer that comprises from about 30% to 70% of the total thickness of the multi-layer film. One advantage in forming multi-layer films is that specific properties can be designed into the film, and, by making the films multi-layer, the more costly ingredients can be relegated to the layers where they are most likely to be needed. Such films may also contain fillers for various purposes, including, for example, opacifying films.

By utilizing light refracting fillers, which have a refractive index different than that of the polymeric material in the film layer, an opaque film can be produced without stretching of the film as part of the manufacturing process. The pigmentation results from the scattering of light rays refracted from fillers and not as a result of voids created by stretching of film. Titanium dioxide, zinc oxide, and zinc sulphide work well with the polymeric materials to form the film layer and cause opacification by light refraction. Filler films are also disclosed in U.S. Pat. No. 4,116,892.

However, many of these films have performance limitations. The incorporation of fillers into films may lead to diminished properties such as tensile strength and yield stress. Therefore, the search continues for improved multi-layer polymeric films and methods for making the same. In particular, it would be desirable to have higher performance, lower cost multi-layer polymeric films. Higher performance includes providing multi-layer films with lower basis weights and higher opacities that are not brittle and do not tear easily.

Furthermore, some consumers display an aversion to purchasing products that are derived from petrochemicals. In such instances, consumers may be hesitant to purchase products made from limited non-renewable resources such as petroleum. Other consumers may have adverse perceptions about products derived from petrochemicals being “unnatural” or not environmentally friendly.

Accordingly, it would be desirable to provide a multi-layer polymeric film which comprises lower basis weight thereby reducing the use of petroleum and lowering costs and potentially enabling the affordable use of non-petroleum source resins, where the multi-layer polymeric film has improved performance characteristics and, in some cases, higher opacities to satisfy product and/or packaging needs.

### SUMMARY

The present disclosure generally relates to multi-layer polymeric films and methods of forming the same.

The multi-layer polymeric film comprises a first layer (or an “A” layer) and a second layer (or a “B” layer). The “A” layer comprises a first base polymer and a first inclusion substantially disposed therein. The first inclusion comprises a first material. The first material has a higher elastic modulus than the first polymer. The “B” layer comprises a second base polymer and a second inclusion substantially disposed therein. The second inclusion comprises a second material. The second material has a higher elastic modulus than the second polymer. The film may comprise additional layers including, but not limited to a skin layer that forms at least one of the outer surfaces of the multi-layer polymeric film. The various layers of the multi-layer film may comprise any suitable base (or “matrix”) polymer(s) including bio-based polymers and/or post consumer recycled polymers.

The first material and the second material may be the same or different types of material and may comprise immiscible hard polymers, minerals, ceramics, or other inclusion materials. For example, the first material and the second material may both comprise immiscible hard polymers. In other embodiments, the first material and the second material may both comprise a mineral or a ceramic. In other embodiments, the first material may comprise an immiscible hard polymer, and the second material may comprise a mineral or a ceramic. In some cases, the hard polymer can be selected so that it will flow into structures, such as structures that will form reinforcing bodies within the polymer matrix during melt processing. The hard polymer may be chosen to elongate during melt processing (formation of the film, for example, during a casting or blowing process) to create a high aspect ratio structures in the film layers.

In some embodiments, the “A” layer and the “B” layer may be adjacent and differ in at least one of the following: the first polymer and the second polymer are different; the first material and the second material are different; and/or the volume percent of the first material in the “A” layer and the volume percent of the second material in the “B” layer are different. In some embodiments, the ratio of volume percent of the first inclusion in the “A” layer to the volume percent of the second inclusion in the “B” layer may range from about 1:1.2 to about 1:5, or vice versa.

In some embodiments, each of the “A” layers and the “B” layers may alternate. In some embodiments, the multi-layer polymeric film comprises at least two “A” layers and at least two “B” layers. In some embodiments, the A and B layers may form a plurality of repeating paired layers. In some embodiments, at least one of the first material and the second material may provide void-initiating properties when the multi-layer film is stretched. In some cases, one of the first material and the second material may provide void-initiating properties when the multi-layer film is stretched, and the other of the first and second material need not provide void-initiating properties when the film is stretched.

A method of forming a multi-layer polymeric film is also provided. In one embodiment, the method comprises preparing a first composition, preparing a second composition, and co-extruding the first composition and the second composition into a plurality of alternating layers. The first composition comprises a first polymer and a first inclusion. The first inclusion is immiscible in the first polymer. The first inclusion comprises a first material. The first material has a higher elastic modulus than the first polymer. The second composition comprises a second polymer and a second inclusion. The second inclusion is immiscible in the second polymer. The second inclusion comprises a second material. The second material has a higher elastic modulus than the second polymer. After the layers are formed, the first inclusion is substantially disposed in the first layer and the second inclusion is substantially disposed in the second layer. In some embodiments, each alternating layer may differ in at least one of the following: the first polymer and the second polymer are different; the first material and the second material are different; or, there is a difference in concentration of the first and second materials in the respective first and second polymers. After the film is formed, if desired, the film may be stretched. Stretching may be used for various purposes including, but not limited to initiating micro voids, and/or improving various properties of the film, such as opacity.

### BRIEF DESCRIPTION OF THE DRAWINGS

FIG. 1 is a representative view of a multi-layer polymeric film having two layers.

FIG. 2 is a representative view of a multi-layer polymeric film having “n” layers, wherein each layer further includes inclusion materials.

FIG. 3 is a photomicrograph taken from an atomic force microscopy image showing a cross-sectional view of a non-activated multi-layer polymeric film having an inclusion material in certain of the layers.

FIG. 4A is a photomicrograph taken from an atomic force microscopy image showing a cross-sectional view of a non-activated multi-layer polymeric film having at least some inclusion material in each of the layers, looking into the film from the machine direction.

FIG. 4B is a cross-sectional view of the film shown in FIG. 4, shown looking into the film from the cross-machine direction.

FIG. 5A is a photomicrograph taken from an atomic force microscopy image showing a cross-sectional view of an activated multi-layer polymeric film having an inclusion material in certain of the layers.

FIG. 5B is an enlarged view of a portion of FIG. 5A.

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the absence of particular elements in any of the exemplary embodiments, except as may be explicitly delineated in the corresponding written description. The drawings are not necessarily to scale.

### DETAILED DESCRIPTION

I. Definitions

As used herein, the following terms shall have the meaning specified thereafter:

“Bio-based content” refers to the amount of carbon from a renewable resource in a material as a percent of the mass of the total organic carbon in the material, as determined by ASTM D6866-10, method B. Note that any carbon from inorganic sources such as calcium carbonate is not included in determining the bio-based content of the material.

“Cavitation” refers to formation of voids within a layer or multiple layers of a film due to activation/stretching of the film.

“Hard polymers” refers to polymers having an elastic modulus at least 30% higher than the elastic modulus of the respective base polymer.

“Renewable resource” refers to a natural resource that can be replenished within a 100 year time frame. The resource may be replenished naturally, or via agricultural techniques. Renewable resources include plants, animals, fish, bacteria, fungi, and forestry products. They may be naturally occurring, hybrids, or genetically engineered organisms. Natural resources such as crude oil, coal, and peat which take longer than 100 years to form are not considered to be renewable resources.

In the context of the present disclosure, “immiscible” and/or “incompatible” refers to microscopically separate and distinct polymeric solid phases. The distinct microscopic solid phases differentially strain upon deformation, such as in a stretching process, thereby creating micro-voids or cavitation between the phases with an ensuing increase in opacity in compatibilizer free compositions.

The phrase “substantially disposed therein”, as used herein, includes structures in which the inclusion is located entirely within a layer, and also those in which the inclusion may extend at least partially into an adjacent layer or layers.

Unless otherwise stated, whenever the percentage of a layer that is occupied by an inclusion is described herein, the percentage refers to volume percent, or volume fraction. Volume fraction of a material is calculated in the normal means from standard temperature component densities (ρᵢ) and mass fractions (mᵢ). For example, when formulating for a two component system (from components 1 and 2) at standard temperature, the volume fraction of component 1 can be calculated with the equation below:

$${v}_{f 1} = \frac{{m}_{1} / {ρ}_{1}}{( {m}_{1} / {ρ}_{1} + {m}_{2} / {ρ}_{2} )}$$

The terms “standard conditions” or “standard temperature”, as used herein, refer to a temperature of 77° F. (25° C.) and 50% relative humidity. When the formula is not available, the volume fraction of a film can be calculated by averaging two dimensional cross-section serial images of films using standard stereology techniques as described in C. Maestrini, M. Merlotti, M. Vighi and E. Malaguti, Second phase volume fraction and rubber particle size determinations in rubber-toughened polymers: A simple stereological approach and its application to the case of high impact polystyrene, Journal of Materials Science, 27(22), 5994-6016.

The present invention is directed to multi-layer films and methods of making the same. The films may have a lower basis weights, improved mechanical properties, and/or higher opacities than certain other films, for example, such as those made of the same compositions but without the inclusions described herein, and/or from the same materials but with fewer total layers.

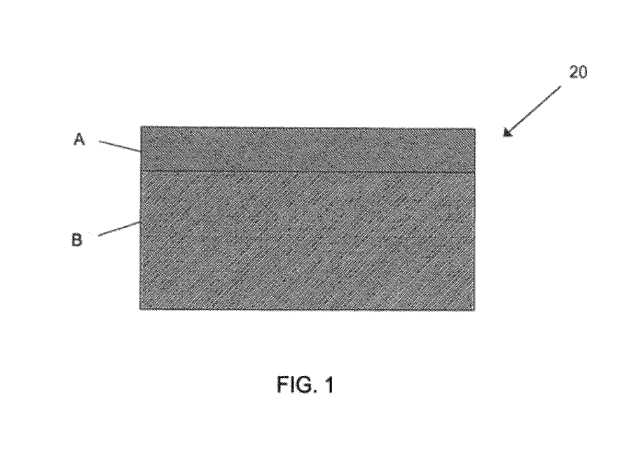

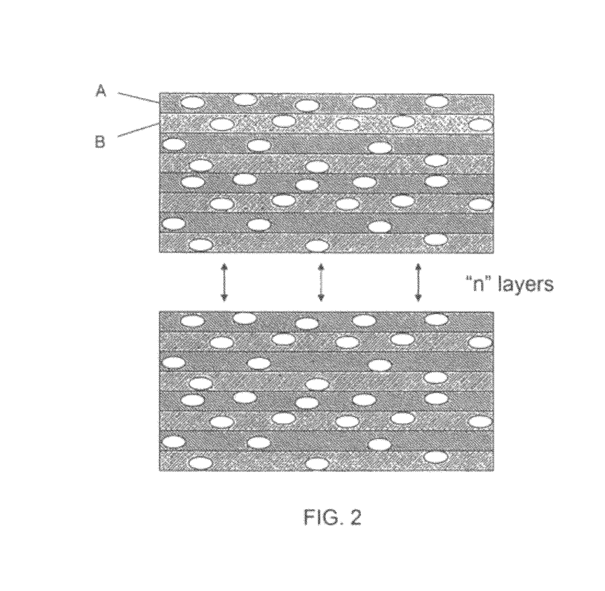

Referring to FIG. 1, the invention comprises a multi-layer film 20 comprising at least an “A” layer and a “B” layer. The A and B layers can be arranged in layered relation relative to each other (e.g., FIG. 1) or in a multiple, repeating layer arrangement (e.g., FIG. 2). As shown in FIG. 2, the multi-layer polymeric film can comprise “n” number of layers of the A and B layers. In various embodiments, the film may include two, three, or more repeating contiguous pairs of A/B layers which can be disposed in numerous arrangements, including but not limited to: throughout the entire structure; through portions of the film thickness; or distributed in numerous repeating contiguous groups within the film. In certain embodiments, the A and B layers may combine to comprise at least 40% of the overall multi-layer polymeric film's cross-section. The multi-layer polymeric films contemplated herein may include additional layers relative to the depictions illustrated in FIGS. 1 and 2. For example, additional layers, which are neither an “A” layer nor a “B” layer, (e.g., a film “C” layer) may be included in the multi-layer polymeric film. The C layer(s) may be comprised of polymeric or polyolefin resins, and may be included for any suitable purpose, including to further modify the film properties.

While FIGS. 1 and 2 generally illustrate various layer arrangements for multi-layer polymeric films, it will be appreciated that such multi-layer polymeric films can comprise from about 4 layers to about 1,000 layers; in certain embodiments from about 5 layers to about 200 layers; and in certain embodiments from about 7 layers to about 100 layers.

The multi-layer polymeric films contemplated herein can have a thickness from about 4 micrometers to about 100 micrometers, alternatively from about 4 micrometers to about 50 micrometers, or from about 6 micrometers to about 20 micrometers. Each of the individual “A” layers and the “B” layers can have any suitable thickness, including but not limited to a thickness of greater than or equal to about 50, 100, 200, or 300 nanometers and less than or equal to about 1, 2, 2.5, or 5 micrometers or more, or any range of thickness between two of these numbers. Thus, in some cases, the films can be considered to be micro-layer films. It will be appreciated that the “A” layer and the “B” layer can have substantially the same or different thicknesses. In certain embodiments, the thickness of “A” layer to the thickness of the “B” layer can range from a ratio of about 1:4 to about 4:1. The multi-layer films can have a basis weight from about 4 gsm to about 100 gsm, alternatively from about 4 gsm to about 30 gsm, or from about 6 gsm to about 18 gsm.

The “A” layer and the “B” layer of the multi-layer polymeric film can each comprise a base or matrix polymer. The base polymer is capable of being formed into a film, and will form a matrix in which the inclusions are distributed. Certain base polymers include polyolefins, particularly polyethylenes, polypropylenes, polybutadienes, polypropylene-ethylene interpolymer and copolymers having at least one olefinic constituent, and any mixtures thereof. Certain polyolefins can include linear low density polyethylene (LLDPE), low density polyethylene (LDPE), medium density polyethylene (MDPE), high density polyethylene (HDPE), isotactic polypropylene, random polypropylene copolymers, impact modified polypropylene copolymer, and other polyolefins which are described in PCT Application Nos. WO 99/20664, WO 2006/047374, and WO 2008/086539. Other base polymers such as polyesters, nylons, polyhydroxyalkanoates (or PHA's), copolymers thereof, and combinations of any of the foregoing may also be suitable. In addition, polyolefin plastomers and elastomers could be used to form the multi-layer polymeric films. Examples of such suitable polyolefin plastomers and elastomers are described in U.S. Pat. No. 6,258,308; U.S. Publication No. 2010/0159167 A1; and PCT Application Nos. WO 2006/047374 and WO 2006/017518. In one embodiment, such polyolefin plastomers and/or elastomers may comprise up to 25% by volume of the multi-layer polymeric film. Other useful polymers include poly-α-olefins such as those described in PCT Application No. WO 99/20664 and the references described therein.

The base polymer can also comprise materials that provide the film with a bio-based content. Such materials include, but are not limited to materials that are at least partially derived from a renewable resource. Such materials include polymers that are derived from a renewable resource either directly or indirectly through one or more intermediate compounds. Suitable intermediate compounds derived from renewable resources include sugars (including monosaccharides, disaccharides, trisaccharides, and oligosaccharides). Sugars include sucrose, glucose, fructose, and maltose, as well as those derived from other agricultural products such as starch or cellulose. Other suitable intermediate compounds derived from renewable resources include monofunctional alcohols such as methanol or ethanol and polyfunctional alcohols such as glycerol. Other intermediate compounds derived from renewable resources include organic acids (e.g., citric acid, lactic acid, alginic acid, amino acids etc.), aldehydes (e.g., acetaldehyde), and esters (e.g., cetyl palmitate, methyl stearate, methyl oleate, mono-, di-, and triglycerides, etc.).

Additional intermediate compounds such as methane and carbon monoxide may also be derived from renewable resources by fermentation and/or oxidation processes.

Intermediate compounds derived from renewable resources may be converted directly into polymers (e.g., lactic acid to polylactic acid) or they may be further converted into other intermediate compounds in a reaction pathway which ultimately leads to a polymer useful in a multi-layer film. An intermediate compound may be capable of producing more than one secondary intermediate compound. Similarly, a specific intermediate compound may be derived from a number of different precursors, depending upon the reaction pathways utilized.

Particularly desirable intermediates include olefins. Olefins such as ethylene and propylene may also be derived from renewable resources. For example, methanol derived from fermentation of biomass may be converted to ethylene and or propylene, which are both suitable monomeric compounds, as described in U.S. Pat. Nos. 4,296,266 and 4,083,889. Ethanol derived from fermentation of a renewable resource may be converted into the monomeric compound ethylene via dehydration as described in U.S. Pat. No. 4,423,270. Similarly, propanol or isopropanol derived from a renewable resource can be dehydrated to yield the monomeric compound of propylene as exemplified in U.S. Pat. No. 5,475,183. Propanol is a major constituent of fusel oil, a by-product formed from certain amino acids when potatoes or grains are fermented to produce ethanol.

Charcoal derived from biomass can be used to create syngas (i.e., CO+H₂) from which hydrocarbons such as ethane and propane can be prepared (Fischer-Tropsch Process). Ethane and propane can be dehydrogenated to yield the monomeric compounds of ethylene and propylene.

Other sources of materials to form polymers include post-consumer recycled materials. Sources of post-consumer recycled materials can include plastic bottles, e.g., soda bottles, plastic films, plastic packaging materials, plastic bags and other similar materials which contain synthetic materials which can be recovered.

Such materials that may provide the film with a bio-based content and post-consumer recycled materials are described in U.S. patent application Ser. No. 13/084,630, filed Apr. 12, 2011.

The base polymer or polymers (if the layers comprise a blend of more than one polymer) used in the respective layers can have any suitable elastic modulus. In some embodiments, it may be desirable for the base polymer (or polymers) without the inclusions therein, to have an elastic modulus greater than or equal to about any of the following: 150 MPa, 160 MPa, 170 MPa, 175 MPa, 180 MPa, 190 MPa, 200 MPa, or more.

The base polymer (or polymers) used in the respective layers, in the various embodiments described herein, may comprise any suitable volume percentage of the respective layers, such as from about 50% to about 97% by volume, alternatively from about 50% to about 95% by volume, alternatively from about 60% to about 90% by volume of the respective layer. If a given layer contains a mixture of two or more base polymers, the volume percentages in the preceding sentence apply to the total amount of all base polymers in the layer.

In some embodiments, the base polymer used in respective adjacent film layers can be substantially the same. For example, the “A” layer and the “B” layer shown in FIGS. 1 and 2 can comprise the same base polymers. Materials such as LLDPE and MDPE are considered to comprise the same base polymers herein since they both comprise variations of the same polymer, polyethylene. In certain embodiments, the LLDPE and the MDPE base polymers can be made into a cast film having a density from about 0.905 g/cm³ to about 0.945 g/cm³, alternatively from about 0.910 g/cm³ to about 0.935 g/cm³. The melt index for such cast films (e.g., LLDPE and MDPE) can be from about 0.8 g/10 min to about 6 g/10 min, alternatively from about 1 g/10 min to about 5 g/10 min LLDPE and MDPE can also be formed as blown films having a melt index ranging from about 0.4 g/10 min to about 2 g/10 min.

In other embodiments, the base polymers used in respective adjacent film layers can be substantially different. This difference can be described in either mechanical property differences or chemical compositional differences between polymer A and polymer B. For example, the “A” layer and the “B” layer of FIGS. 1 and 2 could comprise different base polymers such as the “A” layer could comprise LLDPE and the “B” layer could comprise isotactic polypropylene. It is well known that for polyolefins, comonomer type and molar content can substantially change the mechanical properties and/or polar interaction of their respective polymers. Comonomer types for polyolefins include ethylene, propylene, butene, hexene, octene, styrene, vinyl acetate, methyl acrylate, acrylic acid, maleic anhydride. A substantial difference can include a 30% difference in modulus if the polymeric layers are made into films and the modulus compared. A substantial difference also includes the use of molar percent differences of at least 2 mole percent in the included monomers within the polyolefin polymer. Thus, in some embodiments, the molar percent differences may be at least about 5 mole percent in the included monomers within the polyolefin polymer.

Furthermore, when selecting base polymers for the respective layers of the multi-layer polymeric film, such layers can be compatible and self-adhering to each other layer to prevent problems in joining the two or more layers into a substantially continuous, unitary multi-layer polymeric film.

In addition to, or alternative to, varying the base polymers used for the alternating and adjacent film layers, the respective film layers can further comprise an inclusion material to provide improved property characteristics to the multi-layer polymeric film. For example, each of the “A” layer and the “B” layer as generally illustrated in FIG. 2 could include an inclusion material. These inclusion materials are contemplated to have a higher elastic modulus than the elastic modulus of the respective base polymers. In certain embodiments, the inclusion materials can have an elastic modulus at least 30%, 50%, 100%, or 200% higher than the elastic modulus of the respective base polymers. These inclusion materials can make up a significant portion of the multi-layer polymeric film. In certain embodiments, the inclusion materials in the film layers can comprise from about 3% to about 50%, alternatively from about 10% to about 50%, from about 10% to about 40%, or from about 15% to about 30%, by volume of the layer. In some embodiments, the elastic modulus of the first inclusion in the “A” layer may be greater than (or less than) the elastic modulus of second inclusion in the “B” layer. In various embodiments, the first and second inclusions may exceed the elastic modulus of their respective base polymers by any of the above percentages, and the percentages by which their elastic modulus exceeds that of their respective base polymers, can differ.

Inclusion materials can include a variety of classes of materials, including, for example, immiscible hard polymers and/or minerals and/or ceramics. In order to achieve improved property characteristics for the multi-layer polymeric film, it may be desired to include different classes of inclusion materials within the respective adjacent film layers, or to vary the type of inclusion material within the same class for each of the adjacent film layers. For example, in one embodiment, “A” layer can include an immiscible hard polymer within its polymer matrix and “B” layer can include a mineral within its polymer matrix (or vice versa). In an alternative embodiment, the “A” layer can include a first immiscible hard polymer and the “B” layer can include a second immiscible hard polymer, where the first and second immiscible hard polymers are different. In another embodiment, the “A” layer can include a first mineral and the “B” layer can include a second mineral, wherein the “A” layer and the “B” layer differ in at least one of the following respects: the first and second minerals are different; the first and second minerals exhibit substantially different geometrical shapes or sizes; and/or the first and second minerals differ in volume concentration in their respective layers by a ratio of at least about 1:1.2.

The elastic modulus of polymers is measured by the standard technique in ASTM D882, or secondary methods such as secant modulus at 2% measured using the same standard. The secondary methods are used for materials where elastic modulus measurement is difficult as discussed in the standard. Although estimates of the elastic modulus can be obtained using references such as Materials Science of Polymers for Engineers, Osswald and Menges, Hanser Publishing, 1995, Table 1 in appendix, for the purpose of the appended claims, measurements as specified in ASTM D882 shall be used to measure elastic modulus of polymers. Minerals and ceramics generally have a much higher modulus than the base polyolefin resins discussed herein. Therefore, for the purpose of the appended claims, minerals and ceramics are presumed to have an elastic modulus that is at least 30% higher than the elastic modulus of the polymer, and the elastic modulus of minerals and ceramics is not measured. If it is nonetheless of interest to determine the elastic modulus of minerals, the elastic modulus of different minerals is unique to each mineral. For example, for kyanite, the mineral modulus can be measured directly or indirectly as discussed in journal references such as “Fracture toughness, hardness, elastic modulus of kyanite investigated by a depth-sensing indentation technique”, American Mineralogist, 93, 844-852 (2008).

The immiscible hard polymers can include, but are not limited to: polystyrene, high impact polystyrene, polybutylene terephthalate, polytrimethylene terephthalate, polycarbonate, polylactic acid, polymethyl methacrylate, cellulose acetate, thermoplastic starch, polyhydroxyalkanoates (or PHA's) (provided that the base polymer is not also the same polymer such as a PHA), and combinations thereof. It will be appreciated that other hard polymers that can be processed with polyolefins which demonstrate micro-voiding upon suitable stretching can also be useful.

Thermoplastic starch refers to the combination of highly destructured starch and plasticizer. Natural starch is generally granular and does not melt before it degrades thus rendering it non-thermoplastic. Destructuring is the process in which the granular nature of the starch is largely removed through various means including thermal and mechanical and most involve the utilization of water as the destructuring agent. When largely destructured starch is combined with the appropriate plasticizer, the starch/plasticizers system behaves like a thermoplastic and is termed thermoplastic starch.

Starch refers to any starch including natural and or chemically modified. Starch can be derived from wheat, potato, rice, corn, tapioca, cassava, and other origins. Starch is a polysaccharide that contains both linear chains, amylose, and highly branched chains, amylopectin. The chemically modified starches may be reacted with different functional groups and/or cross-linked The hydroxyl groups in the starch can be substituted to form esters and ethers of varying degree of substitution. Starches can be extended with optional ingredients such as various proteins.

Plasticizers include glycerin, ethylene glycol, ethylene triglycol, propylene triglycol, PEG, PPG, 1-2 propanediol, 1-3 propanediol, 1-2 butanediol, 1-3 butandiol, 1-4 butanediol, 1-5 pentanediol, 1-6 hexanediol, 1,5 hexanediol, 1-2-6-hexanetriol, 1-3-5-hexanetriol, sorbitol, isosorbide, and various derivatives thereof. Plasticizers may also include adipic acid and its derivatives, benzoic acid and its derivatives, citric acid and its derivatives, phosphoric acid and its derivatives, and urea. Other plasticizers are possible and this list is not exhaustive. The plasticizer is usually present in an amount ranging from 1 to 40%.

Thermoplastic starch may also be blended with another thermoplastic polymer or combination of thermoplastic polymers to improve water resistance, processability, or performance. The thermoplastic polymers may include but are not limited to polyolefins (low density polyethylene, linear-low density polyethylene, high density polyethylene, co-polymers of polyethylene, polypropylene, copolymers of polypropylene), polyesters, copolyesters, polyamides, co-polyamides, PBS, PHA, PLA, etc. The thermoplastic starch/thermoplastic blend may include a compatibilizer to improve the interaction of the two materials and facilitate processing and/or improve properties. Compatibilizers may include polar copolymers of polyethylene such as EVA, EAA, EMA, polyethylene-maleic anhydride, polypropylene maleic anhydride, etc.

It is also appreciated that other materials especially including compatibilizing agents or polymers can be used to enhance mechanical properties. Each layer can comprise between 0 and 15 volume percent of a compatibilizing agent. For example, olefinic block copolymers, styrenic block copolymers are typically used to compatibilize polyolefin and/or styrenics such as discussed by Lin in Journal of Applied Polymer Science, Vol 113, 1945-1952 (2009). For polylactic acid and polyolefin systems, compatibilization is possible using either block copolymers as disclosed in US Patent application 2012/0035323 A1 or reactive compatibilization as disclosed in US Patent application 2011/0195210 A1. A substantial difference in mechanical behavior is achieved by the amount of immiscible hard polymer, type of immiscible hard polymer, type of compatibilizer, or level of compatibilizer. A change in compatibilizer level of at least 3% within the layer can change the mechanical properties of the layer. It will be appreciated that the relative rheology of the matrix and immiscible hard polymer as well as the type of melt processing conditions can affect the shape of the included hard polymer and the degree of reinforcement as well as the degree of cavitation in subsequent stretching operations. In certain embodiments, the ratio of the polymer matrix viscosity to the immiscible hard polymer viscosity can range from about 3:1 to about 1:3 to create acceptable morphologies. Examples of suitable immiscible hard polymers are described in U.S. Pat. Nos. 4,377,616, 4,632,869, 5,264,548, 5,288,548 and 6,528,155.

In selecting an immiscible hard polymer, it may be desirable to ensure that it will flow into structures, such as structures that will form reinforcing bodies within the matrix during melt processing. Examples of such structures may be in the form of a ribbon, fibril, or platelet. The immiscible hard polymer may be chosen to elongate during melt processing (formation of the film, for example, during a casting or blowing process) to create high aspect ratio structures, such as those having an aspect ratio greater than or equal to about 2, 5, 10, 15, or 20 up to about 100, or more.

For an immiscible hard polymer that is an amorphous glassy polymer, the immiscible hard polymer is selected having a glass transition temperature below the processing temperature to ensure flow of the immiscible hard polymer in the molten processing state. It is also chosen to have a glass transition temperature above film use temperature. Therefore, for an amorphous immiscible hard polymer, the immiscible hard polymer may have a glass transition temperature between about 70° C. and about 230° C. For an immiscible hard polymer that is semi-crystalline polymer, the immiscible hard polymer is selected so that the melting point is lower than the processing temperature to ensure flow of the immiscible hard polymer in the molten processing state. For a semi-crystalline immiscible hard polymer, the immiscible hard polymer may have a melting point between about 70° C. and about 250° C. The uncompatibilized immiscible hard polymer exhibits micro-voiding in a soft base polymeric film when stretched 100% in the cross-machine direction (or CD) using ASTM D882.

The minerals used as inclusion materials can include without limitation: calcium carbonate, magnesium carbonate, silica, aluminum oxide, zinc oxide, calcium sulfate, barium sulfate, sodium silicate, aluminum silicate, mica, clay, talc, diatomaceous earth, and combinations thereof. It will be appreciated that the size and shape of the minerals can affect the degree of cavitation within the matrix in subsequent stretching operations. In certain embodiments, minerals that are cavitation agents can be spherical or non-spherical with an aspect ratio from about 1 to about 10 or more. Examples of such suitable minerals are described in U.S. Pat. Nos. 4,377,616, 4,632,869, and 6,528,155.

In certain embodiments, the concentration of the inclusion materials can vary. For example, inclusion material may only be in the A or B layer. Alternatively, the volume percent of the inclusion material in “A” layer and the volume percent of the inclusion material in “B” layer may differ. In such cases, the ratio of the volume percent of the inclusion material in the “A” layer to the volume percent of the inclusion material in the “B” layer may, for example, range from about 1:1.2 to about 1:5, alternatively from about 1:1.25 to about 1:4, or from about 1:1.5 to about 1:2, or vice versa. In such embodiments, the multi-layer polymeric film may display improved characteristics as a flat film and/or upon activation of the film as described herein. In certain embodiments, the amount of inclusion material that can be added to a given layer for the film can range from about 5 volume percent to about 50 volume percent. In certain embodiments the amount of immiscible hard polymer that can be added to a given layer for the film can range from about 10 volume percent to about 40 volume percent. In certain embodiments the amount of mineral that can be added to a given layer for the film can range from about 10 volume percent to about 50 volume percent.

The multi-layer polymeric films can further include additional opacifying pigments. Such opacifying pigments generally have a different refractive index from the polymer matrix. For example, at least one of the “A” layer and the “B” layer can further include opacifying pigments. Such opacifying pigments can include zinc oxide, iron oxide, carbon black, aluminum, aluminum oxide, titanium dioxide, talc and combinations thereof. These opacifying pigments can comprise about 0.01% to about 10%, alternatively about 0.3% to about 7%, by volume of the multi-layer polymeric film. It will be appreciated that other suitable opacifying pigments may be employed and in various concentrations. Examples of opacifying pigments are described in U.S. Pat. No. 6,653,523.

Furthermore, the multi-layer polymeric films may comprise additional materials (e.g., additives) such as other polymers (e.g., polypropylene, polyethylene, ethylene vinyl acetate, polymethylpentene, any combination thereof, or the like), a filler (e.g., glass, talc, calcium carbonate, or the like), a nucleation agent, a mold release agent, a flame retardant, an electrically conductive agent, an anti-static agent, a pigment, an antioxidant, an impact modifier, a stabilizer (e.g., a UV absorber), wetting agents, dyes, or any combination thereof.

Each of the layers described herein has two opposed surfaces. The surfaces of the layers may be referred to herein as a first (or “upper”) surface and a second (or “lower”) surface. It is understood, however, that the terms “upper” and “lower” refer to the orientation of the multi-layer film shown in the drawings for convenience, and that if the film is rotated, these layers will still bear the same relationship to each other, but an upper layer may be a lower layer and a lower layer may be an upper layer after the film is rotated. The layers are arranged so at least one surface of a layer is joined to the surface of another layer. In some embodiments, the multi-layer film 20 may further comprise at least one skin or “S” layer. If skin layers are present, the skin layers may each form one of the outer surfaces of the multi-layer film 20.

The skin layer(s), S, can serve any suitable function. Such functions may include, but are not limited to controlling the overall concentration of inclusion material in the multi-layer film 20 (so that the multi-layer film has the desired properties, e.g., softness, etc.) The skin layer(s) may also serve to provide stability during extrusion, and/or provide the multi-layer film with improved properties, such as better bonding to other materials. The skin layer(s) are typically polymeric, and may comprise any of the materials described herein as being suitable for use as the base polymers in the “A” or “B” layers. The skin layers may, thus, be comprised of polyolefin resins. The skin layer(s), however, may be substantially free, or completely free, of inclusion materials. The skin layer(s) may have a total thickness (that is, combined thickness, if more than one) that is from about 20% to about 60% of the thickness of the multi-layer polymeric film.

When there are differences between the adjacent layers, the multi-layer polymeric film may have improved properties relative to films having the same base material composition in adjacent layers. Such properties may include, for example one or more of the following: greater molecular orientation; higher opacities, higher tensile strength, higher tensile yield strength; higher permeability (to vapors and air); and better resistance to tear. However, it should be understood that such improved properties are not required to be present unless specified in the appended claims.

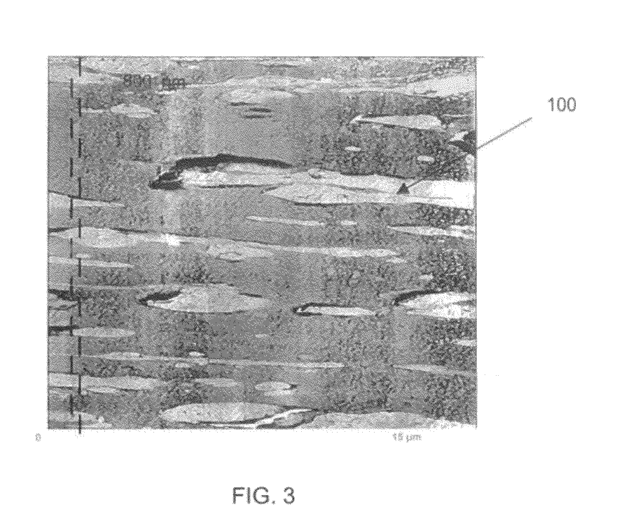

Several examples of multi-layer films are shown in FIGS. 3-5B. FIG. 3 shows a non-activated (non-stretched) polymeric film with inclusion materials as viewed looking into the extruded or machine direction. The multi-layer polymeric film shown in FIG. 3 has two alternating layers forming the film, wherein one layer includes an inclusion material (e.g., 50 wt. % polystyrene (100)) and the other layer does not include an inclusion material. The high concentration of inclusion forms large bodies within the alternating layers and protrudes into adjacent layers.

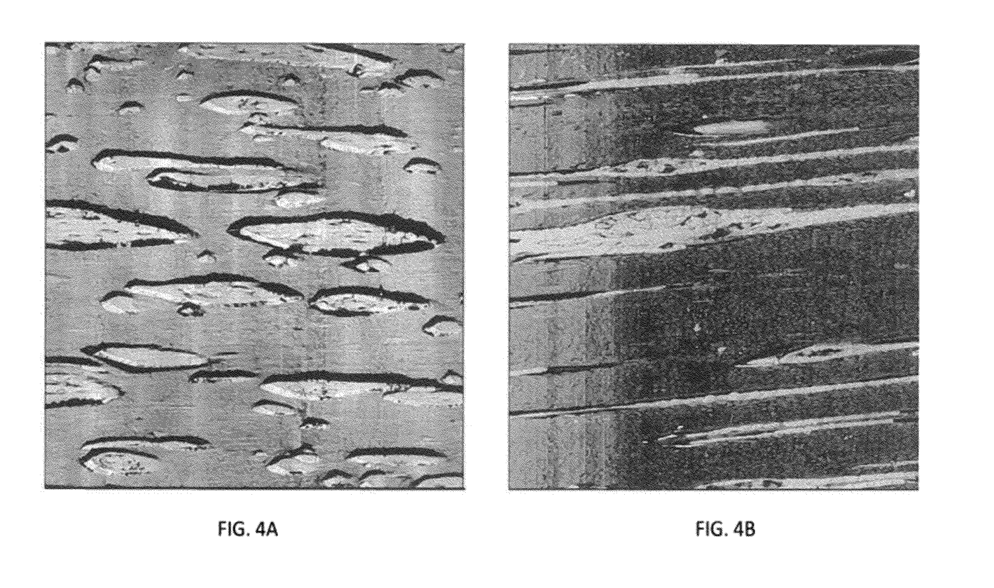

FIGS. 4A and 4B show a non-activated polymeric film with inclusion materials, The multi-layer polymeric film shown in FIGS. 4A and 4B has two alternating layers forming the film, wherein one layer includes an inclusion material of 40 wt. % (37 vol. %) polystyrene (100) in a 60 wt. % (63 vol. %) base LLDPE matrix, and the other layer includes an inclusion material of 10 wt. % (8.8 vol. %) polystyrene (100) in a 90 wt. % (91.2 vol. %) base LLDPE matrix. FIG. 4A shows the machine direction view, i.e. direction in which the film travels during processing. The cross section shows large and small body inclusions that are reflective of the relative concentrations within the layers. Unlike FIG. 3, the inclusions in the film in FIGS. 4A and 4B exhibit a substantially uniform and repeating pattern where the layer with high polystyrene concentration is somewhat isolated by the layer with low polystyrene thus creating a more uniform distribution with minimized agglomeration of the minor phase (the inclusions) within a layer or across layers. The same film viewed in the cross-machine direction of the multi-layer polymeric film is illustrated in FIG. 4B. The inclusion polymer is extended and appears as fibrils and ribbons with high aspect ratios that are estimated between 2 and 100.

To achieve such improved and desired property characteristics, the multi-layer polymeric film may be stretched, drawn, or otherwise activated by mechanical deformation. Such stretching or activation of the multi-layer polymeric film can be achieved using ring roll stretching, machine direction orientation stretching (MDO), cross direction orientation (CDO), mechanical deformation, tenter framing or any combination thereof. Examples of such processes in which to activate the films are described in U.S. Pat. Nos. 3,241,662, 3,324,218, 3,832,267, 4,116,892, 4,153,751, 4,289,832, 4,704,238, 5,691,035, and 5,723,087; U.S. Patent Publication No. 2010/0055429 A1; European Patent and Patent Application Nos. EP 963292 A1, EP 1007329 A1, and EP 1803772 B1.

In one embodiment the multi-layer polymeric film is subject to less than about 50% stretching, and in another embodiment, the multi-layer polymeric film is subject to stretching between about 10% to about 30%. It will be appreciated that a variety of suitable stretching techniques can be used to activate the multi-layer polymeric film, such as a combination of machine direction orientation, cross direction orientation and annealing. One such combination is described in U.S. Pat. No. 7,442,332. Further, it may be desired to activate the multi-layer polymeric film multiple times in order to achieve optimum results relating to improved property characteristics. In addition, it may be desirable that the multi-layer film undergo necking of more than 5%, alternatively, more than 25%, or more than 30%, when tested according to ASTM D 882-95A and the necking test described therein. The activation of the multi-layer film may, in some cases, increase the opacity by at least 5% while decreasing the basis weight by at least 20% from the basis weight of the unactivated multi-layer film. For example, manufacturing multi-layer polymeric films and stretching said films to a basis weight of less than about 15 gsm and containing less than about 7 wt. percent of expensive light scattering titanium dioxide can provide a film having an opacity of at least 60%; and in certain embodiments, an opacity of at least 70%.

As used herein, the term “opacity” refers to the property of a substrate or printed substrate to hide or obscure from view an object placed behind the substrate relative to the point from which an observation is made. Opacity can be reported as the ratio, in percent, of the diffuse reflectance of a substrate backed by a black body having a reflectance of 0.5% to the diffuse reflectance of the same substrate backed by a white body having an absolute reflectance of 89%. The opacity referred to herein is measured as described in ASTM D 589-97, Standard Test Method for Opacity of Paper (15 Â°/Diffuse Illuminant A, 89% Reflectance Backing and Paper Backing). A substrate high in opacity will not permit much, if any, light to pass through the substrate. A substrate having low opacity will permit much, if not nearly all, light to pass through the substrate. Opacity can range from 0 to 100%. As used herein, the term “low opacity” refers to a substrate or printed substrate having opacity less than 50%. As used herein, the term “high opacity” refers to a substrate or printed substrate having opacity greater than or equal to 50%.

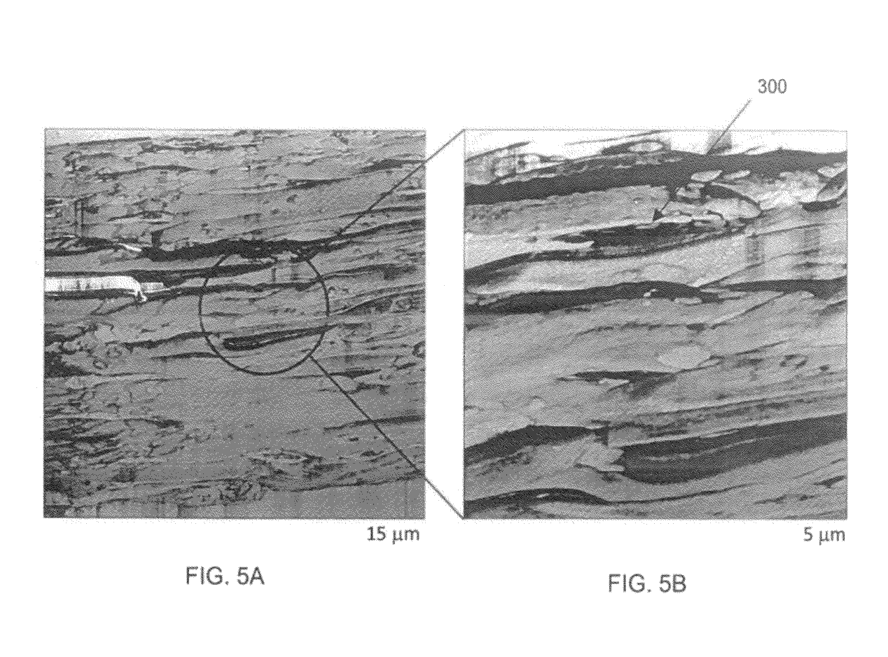

In certain embodiments, the activation of a film can create voids (e.g., cavities), for example, as seen in FIG. 5A. Such voids can form when the polymer in the film stretches more than the inclusion material (e.g., mineral), and can be referred to as stretch-generated or cavitation generated micro-pores. The voids (e.g., 300) formed during cavitation of the film, as shown in FIGS. 5A and 5B, can provide a multi-layer polymeric film with enhanced property characteristics (e.g., higher opacities or higher moisture (or vapor) permeation rates). In certain other embodiments, inclusions can be made incompatible based on the nature of the base polymers selected and/or because of an interfacial agent within the layer. For example, to force incompatibility between polyethylene and polypropylene, polybutylene can be used as an interfacial agent, as described in U.S. Pat. No. 5,500,265 or PCT Publication No. WO 99/52972.

The multi-layer polymeric films described herein can be utilized in a variety of applications, including, but not limited to, personal care absorbent products such as diapers, training pants, incontinence garments, sanitary napkins, and other hygiene articles, bandages, wipes and the like, as well as products such as packaging materials, and other disposable products such as trash bags and food bags. For example, the multi-layer polymeric film may be useful as a liquid impervious backsheet and/or barrier cuff on a disposable absorbent article. In one such application the multi-layer polymeric film can be used as a hygiene film. For example, such a hygiene film can have at least two layers of each of “A” layer and “B” layer that are formed in a repeating pattern and the thickness of each respective layer can be less than about 2 micrometers. As described herein, the multi-layer polymer films can join with other films to form a laminate arrangement. Thus, it will be appreciated that in certain embodiments, a hygiene film (such as the one described herein) can be joined with a nonwoven material to form a laminate structure, particularly one that can be used in hygiene related applications.

The aforementioned multi-layer polymeric films may be prepared by any suitable method. For cast films one method can include employing a high output, high speed cast extrusion line using multiple extruders. The processing conditions will depend upon the materials being used, the processing equipment and the desired film properties. The multi-layer films described herein can also be formed from conventional simple blown film or cast extrusion techniques as well as by using more elaborate techniques such a “tenter framing” process. The present disclosure further relates to a method for making the layered arrangement for a multi-layer polymeric film. Multi-layer polymeric films can be made by known coextrusion processes typically using a flat cast or planar sheet or annular blown film process. Coextruded cast film or sheet structures typically have 3 to 5 layers; however, cast film or sheet structures including hundreds of layers are known. In one method for making a multi-layer film, the number of layers may be multiplied by the use of a device as described in U. S. Pat. No. 3,759,647. Other methods are further described in U.S. Pat. Nos. 5,094,788 and 6,413,595. Here, a first stream comprising discrete, overlapping layers of the one or more materials is divided into a plurality of branch streams, these branch streams are redirected or repositioned and individually symmetrically expanded and contracted, the resistance to flow through the apparatus and thus the flow rates of each of the branch streams are independently adjusted, and the branch streams recombined in overlapping relationship to form a second stream having a greater number of discrete, overlapping layers of the one or more materials distributed in the prescribed gradient or other distribution. In certain embodiments, thin layers can be formed on spiral channel plates and these layers can flow into the central annular channel where micro-layer after micro-layer can then be stacked inside traditional thick layers. Such examples are described in U.S. Patent Publication No. US 2010/0072655 A1. A plurality of layers may be made in blown films by various methods. In US 2010/0072655A1, two or more incoming streams are split and introduced in annular fashion into a channel with alternating plurality of microlayers that are surrounded by standard layer polymeric streams to form blown films containing microlayer regions. For annular dies, a known microlayer process for creating a plurality of alternating layers is made by distributing the flow of the first polymer stream into every odd internal microlayer layer and distributing the flow of the second polymer stream into every even microlayer. This microlayer group is then introduced between channels of polymer streams of standard thickness. Layer multiplication technology for cast films is marketed by companies such as Extrusion Dies Industries, Inc. of Chippewa Falls, Wis. and Cloeren Inc. of Orange, Tex. Microlayer and nanolayer technology for blown films is marketed by BBS Corporation of Simpsonville, S.C.

For example, early multi-layer processes and structures are shown in U.S. Pat. Nos. 3,565,985; 3,557,265; and 3,884,606. PCT Publication WO 2008/008875 discloses a method of forming alternative types of multi-layered structures having many, for example fifty to several hundred, alternating layers of foam and film.

Other manufacturing options include simple blown film (bubble) processes, as described, for example, in The Encyclopedia of Chemical Technology, Kirk-Othmer, Third Edition, John Wiley & Sons, New York, 1981, Vol. 16, pp. 416-417 and Vol. 18, pp. 191-192. Processes for manufacturing biaxially oriented film such as the “double bubble” process described in U.S. Pat. No. 3,456,044 (Pahlke), and other suitable processes for preparing biaxially stretched or oriented film are described in U.S. Pat. No. 4,865,902 (Golike et al.); U.S. Pat. No. 4,352,849 (Mueller); U.S. Pat. No. 4,820,557 (Warren); U.S. Pat. No. 4,927,708 (Herran et al.); U.S. Pat. No. 4,963,419 (Lustig et al.); and U.S. Pat. No. 4,952,451 (Mueller). The film structures can also be made as described in a tenter-frame technique, such as that used for oriented polypropylene.

Other multi-layer polymeric film manufacturing techniques for food packaging applications are described in Packaging Foods With Plastics, by Wilmer A. Jenkins and James P. Harrington (1991), pp. 19-27, and in “Coextrusion Basics” by Thomas I. Butler, Film Extrusion Manual: Process, Materials, Properties pp. 1-80 (published by TAPPI Press (1992)).

The multi-layer polymeric films can be laminated onto another layer(s) in a secondary operation, such as that described in Packaging Foods With Plastics, by Wilmer A. Jenkins and James P. Harrington (1991) or that described in “Coextrusion For Barrier Packaging” by W. J. Schrenk and C. R. Finch, Society of Plastics Engineers RETEC Proceedings, June 15-17 (1981), pp. 211-229. If a monolayer film layer is produced via tubular film (i.e., blown film techniques) or flat die (i.e., cast film) as described by K. R. Osborn and W. A. Jenkins in “Plastic Films, Technology and Packaging Applications” (Technomic Publishing Co., Inc. (1992)), then the film must go through an additional post-extrusion step of adhesive or extrusion lamination to other packaging material layers to form a multilayer film. If the film is a coextrusion of two or more layers (also described by Osborn and Jenkins), the film may still be laminated to additional layers of packaging materials, depending on the other physical requirements of the final film. “Laminations vs. Coextrusion” by D. Dumbleton (Converting Magazine (September 1992), also discusses lamination versus coextrusion. The multi-layer polymeric films contemplated herein can also go through other post extrusion techniques, such as a biaxial orientation process.

### EXAMPLES

### Example 1

One 2-layer multi-layer film (Sample X), and two 32-layer multi-layer films, each of the latter with alternating and adjacent plurality of “A” and “B” layers within films (Samples Y and Z), are formed having the same relative compositions. These materials are made at Extrusion Dies Technologies Inc., Chippewa Falls, Wis. using their ULTRAFLEX® feedblock both with and without layer multiplication technology. A micro-layer feedblock with 0, 1, or 2 four channel inserts enabled making 2, 8, or 32 layer films from an A/B initial layer structure. The average line speed is 150 feet per minute (fpm) (46 m/min.) and the average film basis weight is 18 gsm. The composition for each film sample is shown in Table 1 below. In each film, the “A” layer and “B” layer each include a base polymer and an inclusion material. The base polymer is LLDPE sold by Dow Chemical of Midland, Mich. under the trade name DOWLEX™ 2047G, and the inclusion material is calcium carbonate supplied in a master batch by Heritage Plastic, Picayune, Miss., U.S.A. grade T97813 and contains 70% ground calcium carbonate and 30% polyethylene carrier resin (Ground Calcium Carbonate Master Batch, or “GCC MB”). Furthermore, each of the layers contains an opacifying pigment, titanium dioxide supplied in a master batch by Ampacet, Tarrytown, N.Y., U.S.A. grade 110313-C having 70% titanium dioxide and 30% polyethylene carrier resin (TiO₂ MB). The ratio of the thickness of the “A” layer to the thickness of the “B” layer is 1:1.

Key mechanical properties of the film (e.g., tensile strength and tear resistance) are measured using known analytical techniques. Tensile tests are conducted using ASTM method D882. Elmendorf tear tests are conducted using ASTM D1922. Trapezoidal (Trap) tear tests are conducted using ASTM D5733. The web modulus is measured using a large 610 by 150 mm section of film that is rolled, flatted, and tested in tensile deformation as disclosed in US Patent Application 2003/0105443A1 (Ohnishi et. al.). As illustrated below in Tables 1 and 2, samples Y and Z having a 32 layer arrangement exhibit enhanced property characteristics over the two layer arrangement of sample X.

Holes are observed in the extruded two layer films and the two layer films have poor white color uniformity. The holes are absent in the 32 layer films, and white color is uniform.

TABLE 1
Sample X-Z Compositions

| | | Layer A | | | Layer B | | |
|---|---|---|---|---|---|---|---|
| | Number | | GCC | TiO₂ | | | TiO₂ |
| Sample | of | LLDPE | MB | MB | LLDPE | GCC MB | MB |
| ID | Layers | wt. % | wt. % | wt. % | wt. % | wt. % | wt. % |
| X | 2 | 60 | 32 | 8 | 60 | 32 | 8 |
| Y | 32 | 60 | 32 | 8 | 60 | 32 | 8 |
| Z | 32 | 80.5 | 11.5 | 8 | 46 | 46 | 8 |

TABLE 2
Mechanical Properties of Samples X-Z

| | MD | | | | CD |
|---|---|---|---|---|---|
| | Elmendorf | Tensile | Yield | Web | Elmendorf |
| | Tear Force | Strength | Strength | Modulus | Tear Force |
| Sample | (g) | (N) | (N) | (N/cm) | (g) |
| ID | (mean) | (mean) | (mean) | (mean) | (mean) |
| X | 250.6 | 1.19 | 0.412 | 12.6 | 357.0 |
| Y | 490.0 | 2.44 | 0.956 | 19.0 | 523.5 |
| Z | 504.2 | 2.31 | 0.838 | 14.9 | 552.0 |

### Example 2

One 2-layer multi-layer film, and two 32-layer multi-layer films, each of the latter with alternating and adjacent plurality of “A” and “B” layers within films, are formed having the same relative compositions and using the process as described in Example 1. The composition for each film sample is shown in Table 3 below. Materials used to form the multi-layer polymeric films include LLDPE (DOWLEX™ 2047G), HIPS (high impact polystyrene, Ineos 473KG, League City, Tex., U.S.A.), and titanium dioxide (Ampacet 110313-C). Sixty weight percent (60 wt. %) HIPS and forty weight percent (40 wt. %) LLDPE are compounded (referenced as “c” in Table 3) at 20 lbs/hr. (or pph) (9 Kg/hr.) in a Werner & Pfeiderer ZSK-30 twin screw. This master batch material is listed as HIPS MB and provides for smaller HIPS phase size when introduced into a film. Three samples (Samples 1-3) are produced using the 32 inch (81.3 cm) wide cast film die. Extrusion nominal speed is 150 fpm (46 m/min.) and nominal basis weight is 14 gsm.

TABLE 3
Samples 1-3 Compositions

| | | | | LAYER A | | | | LAYER B | | | |
|---|---|---|---|---|---|---|---|---|---|---|---|
| | | | | | | HIPS | TIO2 | | | HIPS | TIO2 |
| Sample | # | | | LLDPE | HIPS | MB | MB | LLDPE | HIPS | MB | MB |
| ID | LAYERS | LAYER A | LAYER B | wt % | wt % | wt % | wt % | wt % | wt % | wt % | wt % |
| 1 | 2 | LLDPE/ | LLDPE/ | 48% | 0% | 42% | 10% | 48% | 0% | 42% | 10% |
| | | c- | c-HIPS | | | | | | | | |
| | | HIPS | | | | | | | | | |
| 2 | 32 | LLDPE/ | LLDPE/ | 65% | 0% | 25% | 10% | 32% | 0% | 58% | 10% |
| | | c- | c-HIPS | | | | | | | | |
| | | HIPS | | | | | | | | | |
| 3 | 32 | LLDPE/ | LLDPE/ | 48% | 0% | 42% | 10% | 48% | 0% | 42% | 10% |
| | | c- | c-HIPS | | | | | | | | |
| | | HIPS | | | | | | | | | |

The mechanical properties of the resultant films for Samples 1-3 are illustrated in Table 4 below.

TABLE 4
Mechanical Properties of Samples 1-5

| | MD | MD | MD | MD | MD | CD | CD | CD |
|---|---|---|---|---|---|---|---|---|
| Sam- | Load | Tensile | Peak | Yield | Elmendorf | Tensile | Peak | Yield |
| ple | at 2% | Strength | Strain | Load | Tear | Strength | Strain | Load |
| ID | (N) | (N/cm) | (%) | (N) | (g) | (N/cm) | (%) | (N) |
| 1 | 2.21 | 4.00 | 477 | 2.22 | 48 | 2.07 | 588 | 1.23 |
| 2 | 2.01 | 4.84 | 539 | 4.74 | 105 | 2.32 | 585 | 1.35 |
| 3 | 2.05 | 3.57 | 455 | 2.78 | 31.8 | 1.65 | 540 | 1.19 |

### Example 3

Films with the same composition and layer structure as in samples 1-3 of Example 2 are activated in the machine direction (MD), cross direction (CD), or both directions. The films are subjected to MD cold drawing over a span of 8 inches (20 cm) at 300 fpm (92 m/min) and/or CD ring rolling (with corrugated rolls having a pitch (CD tooth-to-tooth spacing (or ridge-to-ridge spacing) of 0.060″ (1.5 mm)) immediately following machine direction orientation. The term “ring rolling” refers to a process using deformation members comprising counter rotating rolls, intermeshing belts or intermeshing plates containing continuous ridges and grooves where intermeshing ridges and grooves of deformation members engage and stretch a web interposed therebetween. An example of a ring rolling apparatus is shown in FIG. 5 of U.S. Pat. No. 7,819,853 B2. The activation is performed at three levels: A is 20% CD activation; B is 20% MD and 20% CD activation; and C is 30% CD activation. The films are immediately relaxed by 180 degree contact angle over an 18 inch (46 cm) diameter heated roll set at 60 degrees C. The property results are exhibited below. It should be noted that the opacity is higher in 32 layer films than in the two layer films after any given stretching process.

TABLE 5
Mechanical Properties of Samples After Stretching

| | | | Web | | | | |
|---|---|---|---|---|---|---|---|
| | | | Mod- | | | CD | Elmendorf |
| For- | | | ulus | Peak | Elmendorf | Peak | CD Tear |
| mula | Proc- | | (N/ | Tensile | Tear Load | Tensile | Load |
| ID | ess | Opacity | cm) | (N/cm) | (g) | (N/cm) | (g) |
| 1 | A | 55.2 | 60.2 | 4.02 | 88.0 | 2.41 | 228 |
| 1 | B | 57.2 | 54.9 | 4.23 | 61.4 | 1.89 | 251 |
| 1 | C | 61.9 | 58.8 | 3.37 | 115.5 | 2.55 | 149 |
| 2 | A | 61.8 | 55.8 | 5.42 | 230.7 | 3.49 | 131 |
| 2 | B | 61.9 | 53.0 | 3.82 | 77.8 | 2.35 | 228 |
| 2 | C | 66.9 | 58.8 | 3.92 | 117.0 | 2.66 | 152 |
| 3 | A | 59.2 | 67.9 | 3.51 | 56.2 | 2.27 | 231 |
| 3 | B | 68.2 | 55.2 | 3.88 | 34.9 | 2.08 | 249 |
| 3 | C | 68.4 | 60.4 | 3.08 | 52.3 | 1.82 | 158 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-layer polymeric film comprising:
a) an “A” layer comprising a first polymer having an elastic modulus and a first inclusion substantially disposed therein, wherein the first inclusion comprises a first material, the first material having a higher elastic modulus than the first polymer; and
b) a “B” layer comprising a second polymer having an elastic modulus and a second inclusion substantially disposed therein, wherein the second inclusion comprises a second material, the second material having a higher elastic modulus than the second polymer,
wherein the “A” layer and the “B” layer are adjacent and differ in at least one of the following:
i) the first polymer and the second polymer are different;
ii) the first material and the second material are different; and
iii) the volume percent of the first inclusion in the “A” layer differs from the volume percent of the second inclusion in the “B” layer,
wherein the A layer and B layer are joined together and combine to form a pair of A/B layers, and the multi-layer film comprises at least two pairs of A/B layers, wherein the A layer in one pair of A/B layers is in contact with the B layer in another pair of A/B layers.

2. The multi-layer polymeric film of claim 1, wherein the first polymer and the second polymer comprise from about 50% to about 95% by volume of the A layer and B layer, respectively.

3. The multi-layer polymeric film of claim 2, wherein the first polymer and the second polymer comprise about 60% to about 90% by volume of the A layer and B layer, respectively.

4. The multi-layer polymeric film of claim 1, wherein the first inclusion and the second inclusion comprise about 5% to about 50% by volume of the A layer and B layer, respectively.

5. The multi-layer polymeric film of claim 4, wherein the first inclusion and the second inclusion comprise about 10% to about 40% by volume of the A layer and B layer, respectively.

6. The multi-layer polymeric film of claim 1, wherein each of the first polymer and the second polymer is selected from the group consisting of: polyolefins, polypropylene, low density polyethylene, linear lower density polyethylene, linear medium density polyethylene, high density polyethylene, polypropylene-ethylene interpolymer, polyhydroxyalkanoates, post consumer recycled polyolefins, and mixtures thereof.

7. The multi-layer polymeric film of claim 1 comprising bio-based materials, wherein the bio-based content of the film is at least 10% as determined by ASTM D6886-10, method B.

8. The multi-layer polymeric film of claim 6, wherein the first polymer and the second polymer comprise polyolefin in an amount comprising at least about 50% by volume of the A layer and the B layer, respectively.

9. The multi-layer polymeric film of claim 1, wherein the first material has an elastic modulus at least 30% higher than the elastic modulus of the first polymer.

10. The multi-layer polymeric film of claim 9, wherein the second material has an elastic modulus at least 30% higher than the elastic modulus of the second polymer.

11. The multi-layer polymeric film of claim 1 having a basis weight from about 4 gsm to about 100 gsm.

12. The multi-layer polymeric film of claim 11 having a basis weight from about 4 gsm to about 30 gsm.

13. The multi-layer polymeric film of claim 1 having a thickness from about 4 micrometers to about 35 micrometers.

14. The multi-layer polymeric film of claim 13 having a thickness from about 4 micrometers to about 20 micrometers.

15. The multi-layer polymeric film of claim 1, wherein the first material comprises a first immiscible hard polymer and the second material comprises a second immiscible hard polymer, wherein each of the first immiscible hard polymer and the second immiscible hard polymer is selected from the group consisting of polystyrene, high impact polystyrene, polybutylene terephthalate, polylactic acid, polyhydroxyalkanoates so long as the first and second hard polymers are not also polyhydroxyalkanoates, and combinations thereof.

16. The multi-layer polymeric film of claim 1, wherein the first material comprises an immiscible hard polymer and the second material comprises at least one of a mineral and a ceramic, wherein the immiscible hard polymer is selected from the group consisting of polystyrene, high impact polystyrene, polybutylene terephthalate, polylactic acid, and combinations thereof; and, the mineral is selected from the group consisting of calcium carbonate, barium carbonate, diatomaceous earth, and combinations thereof.

17. The multi-layer polymeric film of claim 1, wherein the first material comprises at least one of a first mineral and a ceramic, and the second material comprises at least one of a second mineral and a ceramic, wherein each of the first mineral and the second mineral is selected from the group consisting of calcium carbonate, barium carbonate, and combinations thereof.

18. The multi-layer polymeric film of claim 15, wherein the first immiscible hard polymer and the second immiscible hard polymer comprise a volume percent in their respective “A” and “B” layers, and the ratio of the volume percent of the immiscible hard polymer in the “A” layer to the volume percent of the second immiscible hard polymer in the “B” layer is from about 1:1.2 to about 1:5.

19. The multi-layer polymeric film of claim 17, wherein the at least one of the first mineral and ceramic, and the at least one of the second mineral and ceramic comprise a volume percent in their respective “A” and “B” layers, and the ratio of the volume percent of the first mineral in the “A” layer to the volume percent of the second mineral in the “B” layer is from about 1:1.2 to about 1:5.

20. The multi-layer polymeric film of claim 1, wherein at least one of the “A” layer and the “B” layer comprises an opacifying pigment.

21. The multi-layer polymeric film of claim 20 having an opacity of at least about 60% upon activation.

22. The multi-layer polymeric film of claim 20 comprising from about 0.01% to about 10% by volume of the opacifying pigment.

23. The multi-layer polymeric film of claim 22 comprising from about 0.3% to about 7% by volume of the opacifying pigment.

24. The multi-layer polymeric film of claim 20, wherein the opacifying pigment is selected from the group consisting of zinc oxide, iron oxide, carbon black, aluminum, aluminum oxide, titanium dioxide, talc, and combinations thereof.

25. The multi-layer film of claim 1 comprising from about 2 layers of each of the “A” layer and “B” layer to about 1,000 layers of each of the “A” layer and “B” layer.

26. The multi-layer film of claim 25 comprising from about 3 layers of each of the “A” layer and “B” layer to about 50 layers of each of the “A” layer and “B” layer.

27. The multi-layer film of claim 25, wherein each of the layers of “A” layer and “B” layer have a thickness of less than about 5 micrometers.

28. The multi-layer film of claim 27, wherein each of the layers of “A” layer and “B” layer have a thickness of less than about 1 micrometer.

29. The multi-layer polymeric film of claim 1 having two outer surfaces, and further comprising at least one polymeric skin layer joined to one of said “A” layers and “B” layers so that a skin layer forms at least one of the outer surfaces of said multi-layer polymeric film.

30. A multi-layer polymeric film comprising:
a) at least three layers of an “A” layer, each “A” layer comprising a first polymer having an elastic modulus and a first inclusion substantially disposed therein, wherein the first polymer comprises at least 50 volume percent of the “A” layer, wherein the first inclusion comprises a first material, the first material having an elastic modulus at least 50% higher than the first polymer, wherein the first material comprises at least 10 volume percent of the “A” layer; and
b) at least three layers of a “B” layer, each “B” layer comprising a second polymer having an elastic modulus and a second inclusion substantially disposed therein, wherein the second polymer comprises greater than about 50 by volume percent of the “B” layer, wherein the second inclusion comprises a second material, the second material having an elastic modulus at least 50% higher than the second polymer, wherein the second material comprises at least 10 volume percent of the “B” layer,
wherein each of the “A” layers and the “B” layers alternate, wherein each of the first material and the second material have void-initiating properties, and wherein each layer has a thickness no greater than about 5 micrometers.

31. A method of forming a multi-layer polymeric film, the method comprising:
a) preparing a first composition, the first composition comprising a first polymer having an elastic modulus and a first inclusion, the first inclusion being immiscible in the first polymer, the first inclusion comprising a first material, wherein the first material has a higher elastic modulus than the first polymer;
b) preparing a second composition, the second composition comprising a second polymer having an elastic modulus and a second inclusion, the second inclusion being immiscible in the second polymer, the second inclusion comprising a second material, wherein the second material has a higher elastic modulus than the second polymer; and
c) coextruding the first composition and the second composition into a plurality of alternating “A” and “B” layers, wherein the first composition forms the “A” layers and the second composition forms the “B” layers, each alternating layer has a thickness of less than about 2 micrometers, to form a multi-layer polymeric film, and wherein each alternating layer differs with respect to an adjacent layer in at least one of the following:
i) the first polymer and the second polymer are different;
ii) the first material and the second material are different;
iii) the volume percent of the first inclusion differs from that of the second inclusion;
iv) the first composition and the second composition are different; and
v) the volume percent of first and second materials in their respective “A” and “B” layers are different.

32. The method of forming a multi-layer polymeric film of claim 31 further comprising a step d) of stretching the coextruded multi-layer polymeric film.
